(19) United States
(12) Patent Application Publication
(10) Pub. No.: US 2005/0071071 A1
(43) Pub. Date: Mar. 31, 2005

(54) Vehicle control apparatus

(76) Inventor: Yuji Nagata, Chiryu-shi (JP)

Correspondence Address: BURNS DOANE SWECKER & MATHIS L L P, POST OFFICE BOX 1404, ALEXANDRIA, VA, 22313-1404, US

(21) Appl. No.: 10/941,811

(22) Filed: Sep. 16, 2004

(30) Foreign Application Priority Data
Sep. 30, 2003 (JP) 2003-341052

(51) Int. Cl. G06F 7/70

(52) U.S. Cl. 701/70; 701/301

(57) ABSTRACT

An electric controller starts post-collision control when an acceleration of the vehicle detected by means of sensors mounted on the vehicle is greater than an acceleration threshold (i.e., after occurrence of a collision of a vehicle). In the post-collision control, the electric controller fixes the throttle valve opening to a predetermined value, and shifts the transmission from the present gear position to an adjacent lower-side gear position. Moreover, the electric controller controls the hydraulic pressure of the brake such that the vehicle deceleration in the front-rear direction detected by means of the sensors becomes a target deceleration.

### BACKGROUND OF THE INVENTION

1. Field of the Invention

The present invention relates to a vehicle control apparatus for controlling a vehicle after occurrence of a collision.

2. Description of the Related Art

Conventionally, there have been proposed various vehicle control techniques for preventing accidental collisions of vehicles. For example, Japanese Patent Application Laid-Open (kokai) No. 2002-067843 (paragraph 0006 and FIG. 5) proposes a technique for avoiding accidental collision of a vehicle. In this technique, at least one of a collision allowance time, which is a time necessary to avoid a collision with an object, and a collision allowance distance, which is a distance necessary to avoid a collision with the object, is calculated on the basis of the speed and acceleration of the vehicle, the speed and acceleration of the object, and the maximum deceleration calculated from the surface μ gradient of a road surface along which the vehicle is traveling. When at least one of the calculated collision allowance time and collision allowance distance becomes a corresponding threshold or less, at least one of issuance of a warning to the driver, braking force control, and reduction of engine output is carried out so as to prevent collision.

However, the conventional technique does not control the vehicle after occurrence of collision of the vehicle, and gives full responsibility to the driver to generate a force (e.g., braking force) necessary to stop the vehicle safely.

### SUMMARY OF THE INVENTION

An object of the present invention is to provide a technique for controlling a vehicle after occurrence of a collision, to thereby secure the safety of the vehicle in a more reliable manner.

In order to achieve the above object, the present invention provides a vehicle control apparatus comprising acceleration detection means for detecting acceleration of a vehicle; collision determination means for determining, on the basis of the detected acceleration of the vehicle, whether the vehicle has undergone a collision; and automatic deceleration force generation means for automatically generating a deceleration force for decelerating the vehicle when the vehicle is determined to have undergone a collision.

According to the vehicle control apparatus of the present invention, since a deceleration force for decelerating the vehicle is automatically generated after occurrence of a collision of the vehicle, a driver can cause the vehicle to travel safely for the purpose of escaping.

The automatic deceleration force generation means may be configured to generate the deceleration force by actuating a brake of the vehicle.

By virtue of this configuration, after occurrence of a collision, a braking force is forcibly generated through activation of the brake, whereby the speed of the vehicle can be reduced quickly.

The automatic deceleration force generation means may also be configured to generate the deceleration force by controlling an operating state of a drive source, which is mounted on the vehicle and adapted to generate a drive force for driving the vehicle, in such a manner that the drive source serves as a load against travel of the vehicle.

In the case where the drive source of the vehicle is an internal combustion engine, the above-mentioned control for causing the drive source to serve as a load against travel of the vehicle is achieved by means of lowering the output torque of the engine to thereby effect so-called engine braking. In the case where the drive source of the vehicle is an electric motor, the above-mentioned control is achieved by means of causing the motor to effect so-called regenerative braking.

By virtue of this configuration, after occurrence of a collision, a deceleration force can be generated by means of the drive source, whereby the speed of the vehicle can be reduced smoothly.

The automatic deceleration force generation means may also be configured to shift a transmission mounted on the vehicle from a gear position at the time when the vehicle is determined to have undergone a collision to a lower-side gear position. By virtue of this configuration, when the vehicle is determined to have undergone a collision, the transmission is shifted to a lower-side gear position, whereby the deceleration force generated by means of the drive source can be increased further.

The vehicle control apparatus of the present invention may comprise an operation switch for prohibiting automatic generation of the deceleration force.

By virtue of this configuration, when a driver operates the operation switch, automatic generation of the deceleration force is prohibited, thereby enabling the driver to drive the vehicle by him/herself for the purpose of escaping.

Preferably, the automatic deceleration force generation means is configured to continue automatic generation of the deceleration force until the vehicle stops. This configuration reliably stops the vehicle after occurrence of a collision.

The present invention further provides a vehicle control apparatus comprising acceleration detection means for detecting acceleration of a vehicle; collision determination means for determining, on the basis of the detected acceleration of the vehicle, whether the vehicle has undergone a collision; a drive source for generating a drive force for driving the vehicle in accordance with an instruction signal; instruction-signal generation means for generating the instruction signal in response to a drive operation of a driver and for modifying the instruction signal, when the vehicle is determined to have undergone a collision, in such a manner that the drive force generated in accordance with the instruction signal does not exceed a predetermined level.

According to the vehicle control apparatus of the present invention, after occurrence of a collision of the vehicle, the drive force is limited so as not to exceed the predetermined level irrespective of the drive operation of the driver, whereby the driver can cause the vehicle to travel for the purpose of escaping at a safe speed.

The vehicle control apparatus of the present invention may comprise an operation switch for prohibiting the modification of the instruction signal. By virtue of this configuration, when a driver operates the operation switch, the control for limiting the drive force is prohibited, thereby enabling the driver to drive the vehicle by him/herself for the purpose of escaping.

Preferably, the instruction-signal generation means is configured to continue the modification of the instruction signal until the vehicle stops. This configuration can stop the vehicle safely after occurrence of a collision, irrespective of operation of the driver.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a schematic diagram of a vehicle control apparatus according to a first embodiment of the present invention;

FIG. 2 is a flowchart showing a routine which the CPU shown in FIG. 1 executes in order to control an internal combustion engine and an automatic transmission;

FIG. 3 is a flowchart showing a routine which the CPU shown in FIG. 1 executes in order to perform post-collision control; and

FIG. 4 is a flowchart showing a routine which a CPU of a vehicle control apparatus according to a second embodiment executes in order to perform post-collision control.

### DESCRIPTION OF THE PREFERRED EMBODIMENTS

Embodiments of a vehicle control apparatus (vehicle drive control apparatus) according to the present invention will be described with reference to the drawings.

### First Embodiment

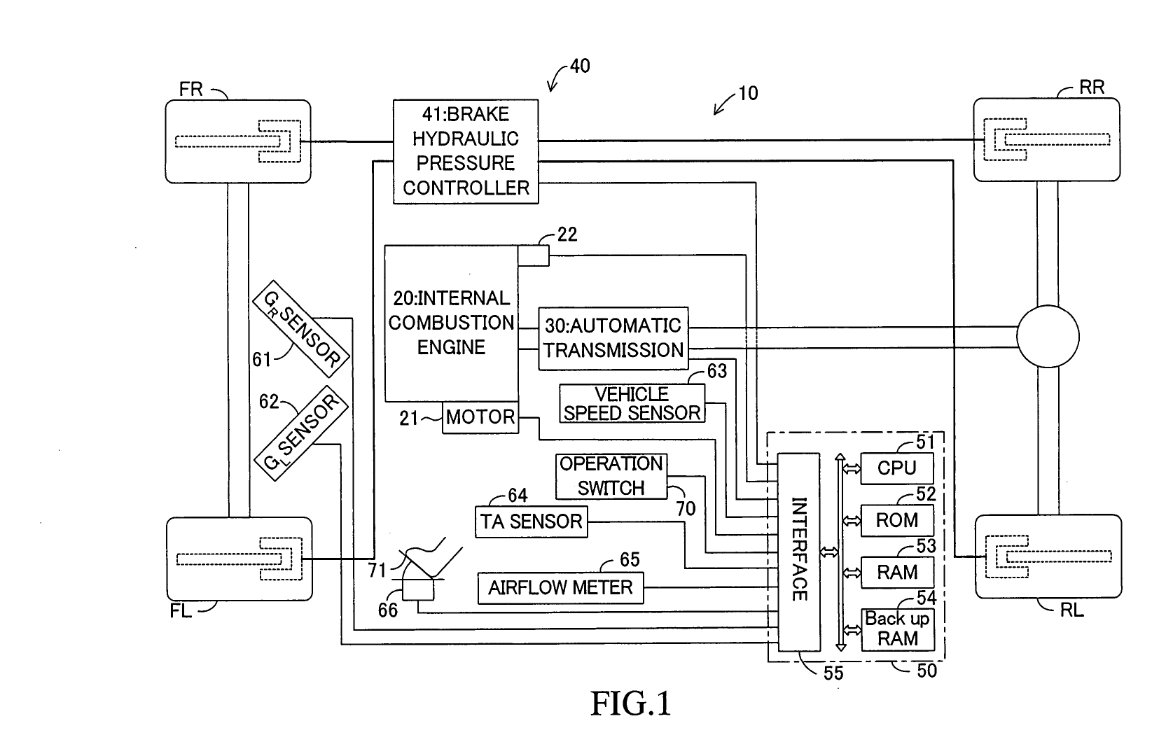

FIG. 1 schematically shows the structure of a vehicle control apparatus 10 according to a first embodiment of the present invention. The vehicle control apparatus 10 includes an internal combustion engine 20, an automatic transmission 30, a brake apparatus 40, and an electric controller (ECU) 50.

The internal combustion engine 20 is mounted on the vehicle, and serves as a drive source which generates a drive force for driving the vehicle. The internal combustion engine 20 includes a motor 21 for controlling the opening of a throttle valve in accordance with an instruction signal; and an injector 22 for injecting fuel. The internal combustion engine 20 generates a drive force (output torque), and changes the generated drive force when at least the motor 21 and the injector 22 are controlled.

The automatic transmission 30 is configured in such a manner that, through control of clutches and brakes of the automatic transmission 30 by means of hydraulic pressure, one of a plurality of transmission paths is selectively brought into a power transmissible state, to thereby determine a gear position. The hydraulic pressure for controlling the clutches and brakes of the automatic transmission 30 is controlled by means of an unillustrated hydraulic control circuit and a plurality of solenoid valves. The automatic transmission 30 converts the drive force generated by means of the internal combustion engine 20 to a vehicle drive torque (torque for rotating the rear wheels in the present embodiment) at a transmission gear ratio (speed reduction ratio, torque ratio) of the determined gear position.

The brake apparatus 40 is configured to press, by means of hydraulic pressure (hereinafter referred to as “brake hydraulic pressure”), brake pads against respective disk rotors which rotate together with respective wheels (front right wheel FR, front left wheel FL, rear right wheel RR, and rear left wheel RL), to thereby generate a braking force, which is one type of decelerating force for decelerating the vehicle. The brake apparatus 40 is equipped with a brake hydraulic pressure controller 41. The brake hydraulic pressure controller 41 includes unillustrated solenoid valves, and the brake hydraulic pressure (accordingly, braking force) is controlled through control of the solenoid valves. Moreover, the brake apparatus 40 includes an unillustrated brake pedal and a brake master cylinder for changing the pressure within the cylinder in response to operation of the brake pedal. The brake master cylinder is connected to the brake hydraulic pressure controller 41. The brake hydraulic pressure controller 41 controls the solenoid valves in such a manner that, during ordinary travel, the pressure generated in the master cylinder serves as the brake hydraulic pressure.

The electric controller 50 is mainly formed of a microcomputer which includes a CPU 51, ROM 52, RAM 53, backup RAM 54, and an input-output circuit (interface) 55.

A G_{R} sensor 61, a G_{L} sensor 62, a vehicle speed sensor 63, a throttle valve opening sensor (TA sensor) 64, an airflow meter 65, an accelerator pedal sensor (Accp sensor) 66, and an operation switch 70 are connected to the electric controller 50, whereby the electric controller 50 receives signals from these sensors and switch. These sensors and switch will now be described.

The G_{R} sensor 61 is a sensor which detects acceleration acting on the sensor along a direction of the detection axis, by use of a piezoelectric element. When an acceleration acts on the G_{R} sensor 61 in the positive direction of the detection axis, the G_{R} sensor 61 outputs a signal G_{R} whose sign is positive and whose magnitude is proportional to the magnitude of the acceleration. When an acceleration acts on the G_{R} sensor 61 in the negative direction of the detection axis, the G_{R} sensor 61 outputs a signal G_{R} whose sign is negative and whose magnitude is proportional to the magnitude of the acceleration. The G_{R} sensor 61 is fixed to the vehicle in an orientation such that, as viewed from above, the detection axis positive direction inclines clockwise by 45 degrees with respect to the heading direction of the vehicle. Accordingly, the G_{R} sensor 61 detects a component of acceleration of the vehicle along a direction which inclines clockwise by 45 degrees with respect to the heading direction of the vehicle as viewed from above.

The G_{L} sensor 62 has the same configuration as does the G_{R} sensor 61. When an acceleration acts on the G_{L} sensor 62 in the positive direction of the detection axis, the G_{L} sensor 62 outputs a signal G_{L} whose sign is positive and whose magnitude is proportional to the magnitude of the acceleration. When an acceleration acts on the G_{L} sensor 62 in the negative direction of the detection axis, the G_{L} sensor 62 outputs a signal G_{L} whose sign is negative and whose magnitude is proportional to the magnitude of the acceleration. The G_{L} sensor 62 is fixed to the vehicle in an orientation such that, as viewed from above, the detection axis positive direction inclines counterclockwise by 45 degrees with respect to the heading direction of the vehicle. Accordingly, the G_{L} sensor 62 detects a component of acceleration of the vehicle along a direction which inclines counterclockwise by 45 degrees with respect to the heading direction of the vehicle as viewed from above.

As a result, the acceleration vector of the vehicle is represented by the vector sum of the acceleration detected by means of the G_{R} sensor 61 and the acceleration detected by means of the G_{L} sensor 62. Accordingly, a signal G indicative of the magnitude of an acceleration of the vehicle can be obtained by substituting the signal G_{R} output from the G_{R} sensor 61 and the signal G_{L} output from the G_{L} sensor 62 into the following equation (1). Further, an acceleration Gz along the front-rear direction of the vehicle can be obtained from the following equation (2).

$$\begin{matrix}G = \sqrt{{G}_{R}^{2} + {G}_{L}^{2}} & ( 1 ) \\ {G}_{Z} = \frac{1}{\sqrt{2}} ( {G}_{R} + {G}_{L} ) & ( 2 )\end{matrix}$$

As can be understood from the above, the G_{R} sensor 61 and the G_{L} sensor 62 constitute acceleration detection means for detecting acceleration of the vehicle.

Notably, in place of the G_{R} sensor 61 and the G_{L} sensor 62, a sensor for airbag deployment may be used as the acceleration detection means of the vehicle control apparatus 10.

The vehicle speed sensor 63 detects speed (SPD) of the vehicle, and outputs a signal indicative of the vehicle speed SPD. The TA sensor 64 detects throttle valve opening TA, and outputs a signal indicative of the throttle valve opening TA. The airflow meter 65 is a meter for measuring the quantity of intake air supplied to the internal combustion engine 20. The accelerator pedal sensor (Accp sensor) 66 detects the amount of movement of the accelerator pedal 71 operated by a driver (hereinafter, referred to as “accelerator pedal opening”), and outputs a signal indicative of the accelerator pedal opening Accp.

The operation switch 70 is used to issue an instruction as to whether to automatically generate a deceleration force for decelerating the vehicle when the vehicle is determined to have undergone a collision. When the operation switch 70 is in an “ON” state, a forced drive control that the vehicle control apparatus 10 performs after occurrence of a collision of the vehicle (control for automatically generating a deceleration force for decelerating the vehicle) is cancelled or prohibited. In other words, when the operation switch 70 is in an “OFF” state, the forced drive control (post-collision control) is performed by the vehicle control apparatus 10 after occurrence of a collision of the vehicle. The operation switch 70 is a switch that is manually operated by the driver, and the operator can operate the operation switch before or after occurrence of a collision of the vehicle.

The motor 21 for controlling the throttle valve opening, the injector 22 for injecting fuel, unillustrated solenoid valves of the hydraulic control circuit of the automatic transmission 30, and unillustrated solenoid valves of the brake hydraulic pressure controller 41 are connected to the electric controller 50. The electric controller 50 sends instruction signals to these components.

More specifically, the electric controller 50 calculates a target throttle valve opening TAtarget corresponding to the accelerator pedal opening Accp detected by means of the accelerator pedal sensor 66, and sends an instruction signal to the motor 21 in such a manner that the actual throttle valve opening TA detected by means of the TA sensor 64 coincides with the target throttle valve opening TAtarget. The motor 21 drives the unillustrated throttle valve of the internal combustion engine 20 in accordance with the instruction signal.

The electric controller 50 determines a fuel injection quantity fi in accordance with the quantity of intake air passing through the airflow meter 65, and sends to the injector 22 an instruction signal corresponding to the determined fuel injection quantity fi. The injector 22 injects fuel in the fuel injection quantity fi according to the instruction signal sent from the electric controller 50.

As a result of the throttle valve opening TA and the fuel injection quantity fi being controlled as described above, the output torque of the internal combustion engine 20 is changed and controlled.

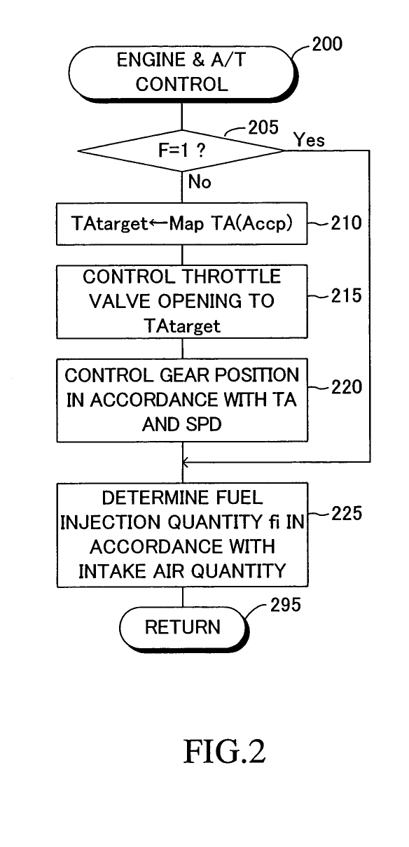

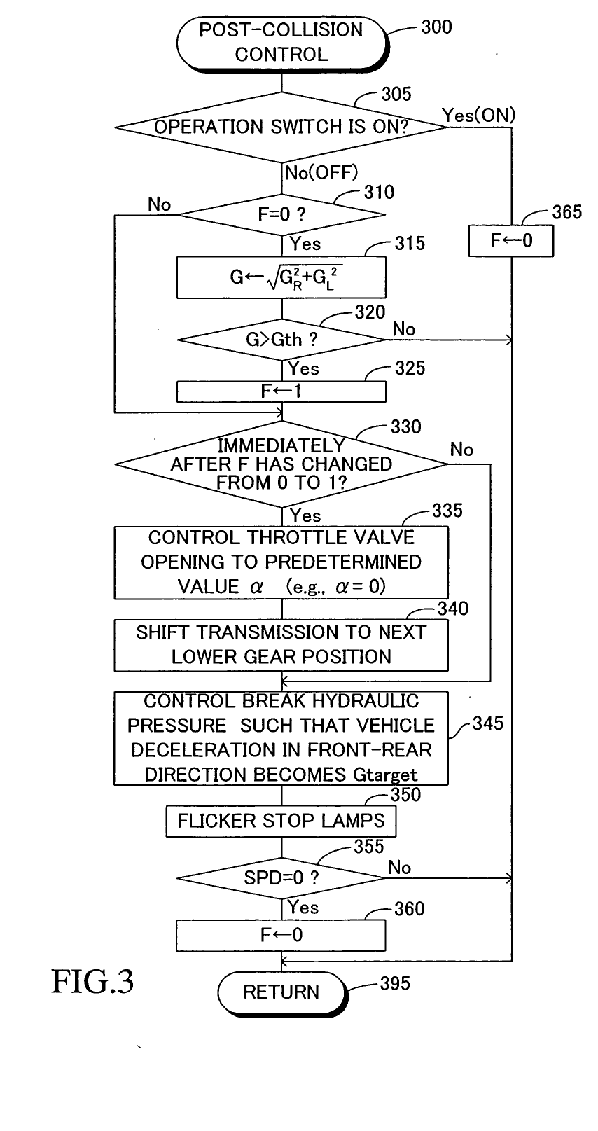

Next, operation of the vehicle control apparatus 10 having the above-described configuration will be described with reference to FIGS. 2 and 3. FIG. 2 is a flowchart showing a routine (program) that the CPU 51 executes during ordinary travel and after occurrence of a vehicle collision so as to control the internal combustion engine 20 and the automatic transmission 30. FIG. 3 is a flowchart showing a routine (program) that the CPU 51 executes so as to perform vehicle control after occurrence of a vehicle collision. The CPU 51 repeatedly performs these routines at predetermined time intervals.

(1) The case where the vehicle starts ordinary travel (before occurrence of a collision), and the operation switch 70 is off:

First, there is described the case where a collision of the vehicle has not yet occurred, and the operation switch 70 is in the OFF state. When a predetermined timing is reached, the CPU 51 starts processing of the routine of FIG. 2 from Step 200, and proceeds to Step 205 so as to determine whether the value of a post-collision control execution flag F is “1”.

The post-collision control execution flag F has been previously set to “0” in an initialization routine executed when an ignition switch is brought from an OFF state to an ON state. The post-collision control execution flag F is a flag to be used to determine whether the vehicle control apparatus 10 is executing post-collision control. When assuming a value of “1,” the post-collision control execution flag F indicates that the post-collision control is currently being executed. When assuming a value of “0,” the post-collision control execution flag F indicates that the post-collision control is not currently being executed.

Immediately after the vehicle starts ordinary travel, since the value of the post-collision control execution flag F is “0,” the CPU 51 executes control for ordinary travel shown in Steps 210 to 225. Specifically, in Step 210, the CPU 51 calculates a target throttle valve opening TAtarget on the basis of the accelerator pedal opening Accp detected by means of the accelerator pedal sensor 66, and by use of a map. This map defines the relationship between the accelerator pedal opening Accp and the target throttle valve opening TAtarget, and is stored in the ROM 52 in advance.

Subsequently, the CPU 51 proceeds to Step 215, and sends an instruction signal to the motor 21 so as to control the opening of the throttle valve to the target throttle valve opening TAtarget obtained in Step 210. Then, the CPU 51 proceeds to Step 220, and sends instruction signals to the solenoid valves of the automatic transmission 30 so as to attain a gear position determined in accordance with the throttle valve opening TA detected by means of the TA sensor 64 and the vehicle speed SPD detected by means of the vehicle speed sensor 63. After that, the CPU 51 proceeds to Step 225. In Step 225, the CPU 51 determines a fuel injection quantity fi corresponding to the intake air quantity measured by means of the airflow meter 65, and sends to the injector 22 an instruction signal for injecting fuel having the determined fuel injection quantity fi. Subsequently, the CPU 51 proceeds to Step 295 so as to end the current execution of the present routine.

Meanwhile, when a predetermined timing is reached, the CPU 51 starts processing of the routine of FIG. 3 from Step 300, and proceeds to Step 305 so as to determine whether the operation switch 70 is in the “ON” state. Since the operation switch 70 is in an “OFF” state at this timing, the CPU 51 makes a “No” determination in Step 305, and then proceeds to Step 310 so as to determine whether the value of the post-collision control execution flag F is “0.” Since at this timing the post-collision control execution flag F assumes the initial value; i.e., “0,” the CPU 51 proceeds to Step 315 so as to obtain the magnitude G of an acceleration of the vehicle from the output values G_{R} and G_{L} of the two acceleration sensors.

Subsequently, the CPU 51 proceeds to Step 320 so as to determine whether the magnitude G of the acceleration of the vehicle is greater than a predetermined acceleration threshold Gth. In this case, since the vehicle travels in an ordinary state (before occurrence of a collision), the magnitude G of the acceleration of the vehicle is not greater than the threshold Gth. Accordingly, in Step 320, the CPU 51 makes a “No” determination; i.e., determines that post-collision control is not required to start. Thus, the CPU 51 proceeds Step 395 so as to end the current execution of the present routine.

(2) The case where a collision occurs during ordinary travel:

When the vehicle undergoes a collision in such a state, the magnitude G of the acceleration of the vehicle becomes greater than the threshold Gth. Therefore, upon execution of the routine of FIG. 3, the CPU 51 makes a “Yes” determination in Step 320 subsequent to Steps 300-315, and then proceeds to Step 325 so as to set the value of the post-collision control execution flag F to “1,” thereby indicating that post-collision control is being executed. After that, the CPU 51 proceeds to Step 330.

In Step 330, the CPU 51 determines whether the present point in time is immediately after the value of the post-collision control execution flag F has changed from “0” to “1.” This determination can be performed through comparison between data indicating the current status of the post-collision control execution flag F and data indicating the status in a previous processing cycle, which is stored in the RAM 53.

The present point in time is immediately after the value of the post-collision control execution flag F has changed from “0” to “1.” Therefore, the CPU 51 makes a “Yes” determination in Step 330, and proceeds to Step 335 so as to send to the motor 21 an instruction signal for fixing the throttle valve opening TA to a predetermined value α (for example, α=0; that is, the throttle valve is completely closed). Subsequently, the CPU 51 proceeds to Step 340 so as to send, to the solenoid valves of the automatic transmission 30, instruction signals for shifting the automatic transmission 30 from the current gear position to an adjacent lower-side gear position; i.e., a gear position that is lower by one gear position. After that, the CPU 51 proceeds to Step 345.

Next, in Step 345, the CPU 51 send to the solenoid valves of the brake hydraulic pressure controller 41 instruction signals for controlling the brake hydraulic pressure such that the vehicle deceleration obtained from the G_{R} sensor 61 and the G_{L} sensor 62 becomes a target deceleration Gtarget. When G_{R}+G_{L}>0, the vehicle is currently accelerating, whereas when G_{R}+G_{L}≦0, the vehicle is currently decelerating. Therefore, the brake is operated in such a manner that during a period in which the inequality G_{R}+G_{L}>0 stands, a relatively large first braking force is generated, and when the inequality G_{R}+G_{L}>0 stands, the acceleration Gz along the front-rear direction determined on the basis of the above-described equation (2) becomes equal to the target deceleration Gtarget. Notably, the target deceleration Gtarget is a target acceleration at which the vehicle is to be decelerated, and assumes a predetermined negative value.

Next, the CPU 51 proceeds to Step 350 so as to cause stop lamps to flicker to thereby inform a following vehicle and others that the vehicle is currently decelerating (or is currently braked through operation of the brake). Subsequently, the CPU 51 proceeds to Step 355 so as to determine whether the vehicle speed SPD has been reduced to zero (that is, whether the vehicle has stopped). The present stage is immediately after a collision is determined to have occurred, and the vehicle has not yet stopped (the SPD is not “0”). Therefore, the CPU 51 makes a “No” determination in Step 355, and then proceeds to Step 395 so as to end the current execution of the present routine.

When the CPU 51 starts the processing of the routine of FIG. 2 from Step 200 in this state, since the value of the post-collision control execution flag F has been set to “1” in the above-mentioned Step 325, the CPU 51 makes a “Yes” determination in Step 205, and then proceeds directly to Step 225 and Step 295. Moreover, when the CPU 51 performs the processing of the routine of FIG. 3, the CPU 51 makes a “No” determination in Step 310 and proceeds directly to Step 330, and makes a “No” determination in Step 330 and then proceeds directly to Step 345.

As described above, when execution of the post-collision control is started and the value of the post-collision control execution flag F is set to “1,” Steps 210 to 220 of FIG. 2 are not executed. Therefore, the controls of the internal combustion engine 20 and the automatic transmission 30 for ordinary travel are not performed, and even when the driver operates the accelerator pedal 71, the throttle valve opening TA is maintained at the predetermined value α (=0). Further, since Step 340 is performed only one time immediately after the collision is determined to have occurred, the automatic transmission 30 is maintained at a gear position which is one gear position lower than that used at the time when the collision is determined to have occurred.

When such a state continues, the vehicle is decelerated at the target deceleration Gtarget, and stops after elapse of a certain period of time. When the CPU 51 executes the routine shown in FIG. 3 at that time, the CPU 51 makes a “Yes” determination in Step 355 subsequent to Steps 305, 310, 330, 345, and 350, proceeds to Step 360 so as to set the value of the post-collision control execution flag F to “0,” and then proceeds to Step 395 so as to end the current execution of the present routine.

As a result, when the post-collision control has been performed after the collision was determined to have occurred and then the vehicle has stopped, the value of the post-collision control execution flag F is reset to “0,” whereby the execution of Steps 210 to 220 of FIG. 2 is resumed. As a result, the vehicle is operated in accordance with operations of the driver.

(3) The case where the operation switch 70 is turned on during performance of post-collision control:

Next, there will be described case where the operation switch 70 is turned on during performance of post-collision control. In this case, when at a predetermined timing the CPU 51 starts the processing of FIG. 3 from Step 300 and proceeds to Step 305, the CPU 51 makes a “Yes” determination, and then proceeds to Step 365 so as to set the post-collision control execution flag F to “0.” Subsequently, the CPU 51 proceeds to Step 395 so as to end the current execution of the present routine.

In this case, the CPU 51 makes a “No” determination in Step 205 of FIG. 2. Therefore, the CPU 51 performs the controls of the internal combustion engine 20 and the automatic transmission 30 for ordinary travel shown in the above-described Steps 210 to 225, and then proceeds to Step 295 so as to end the current execution of the present routine.

(4) The case where the operation switch 70 has been turned on before occurrence of a collision:

Next, there will be described case where the operation switch 70 has been turned on before occurrence of a collision. In this case, when at a predetermined timing the CPU 51 starts the processing of FIG. 3 from Step 300 and proceeds to Step 305, the CPU 51 first makes a “Yes” determination in Step 305, proceeds to Step 365 so as to set the value of the post-collision control execution flag F to “0,” which indicates that post-collision control is not currently being performed, and then proceeds to Step 395 so as to end the current execution of the present routine. In this case as well, since the CPU 51 makes a “No” determination in Step 205 of FIG. 2, the CPU 51 performs the controls of the internal combustion engine 20 and the automatic transmission 30 for ordinary travel.

As described above, when the operation switch 70 is in the “ON” state, the CPU 51 immediately ends the routine of FIG. 3, without proceeding to Step 310 and subsequent steps in FIG. 3, so that post-collision control is not performed.

Notably, the CPU 51 may be configured so as to perform only one of Step 345 and the series of steps of Step 330 to Step 340 shown in FIG. 3.

Moreover, the target deceleration Gtarget used in Step 345 may be made variable. In this case, the target deceleration Gtarget is preferably set such that the greater the magnitude G of the acceleration of the vehicle at the time when a collision of the vehicle is determined to have occurred, the greater the absolute value of the target deceleration Gtarget (i.e., the greater the deceleration with which the vehicle is stopped).

The above description applies to the case where the vehicle control apparatus 10 comprises acceleration detection means (acceleration sensor) for detecting acceleration of a vehicle; collision determination means (Steps 310 to 325) for determining, on the basis of the detected acceleration G of the vehicle, whether the vehicle has undergone a collision; and automatic deceleration force generation means (Steps 330 to 345) for automatically generating a deceleration force for decelerating the vehicle when the vehicle is determined to have undergone a collision.

The automatic deceleration force generation means may be configured to increase the brake hydraulic pressure by mean of the brake hydraulic pressure controller 41 so as to activate the brake (the brake apparatus 40) of the vehicle, to thereby generate the deceleration force (Step 345). Further, the automatic deceleration force generation means may be configured to generate the deceleration force by controlling an operating state of a drive source (for example, the internal combustion engine 20), which is mounted on the vehicle, in such a manner that the drive source serves as a load against travel of the vehicle (Steps 330 and 335). Moreover, the automatic deceleration force generation means may be configured to shift a transmission (automatic transmission 30) mounted on the vehicle from a gear position at the time when the vehicle is determined to have undergone a collision to a lower-side gear position (Step 340).

Since the vehicle control apparatus 10 includes the operation switch 70 for prohibiting the automatic generation of the deceleration force (Step 305), the vehicle can be caused to travel on the basis of operations of the driver if necessary.

Further, the automatic deceleration force generation means is configured to continue the automatic generation of the deceleration force until the vehicle stops (Steps 355 and 360). Accordingly, the vehicle can be stopped without fail after occurrence of a collision.

As described above, after occurrence of a collision of the vehicle, the vehicle control apparatus 10 according to the first embodiment of the present invention, irrespective of drive controls of the driver, forcibly activates the brakes of the brake apparatus 40, controls the internal combustion engine 20 to produce a negative torque, and shifts the automatic transmission 30 to a lower-side gear position, so as to automatically generate a deceleration force for decelerating the vehicle. Therefore, the vehicle can be caused to travel safely for the purpose of escape.

Notably, the vehicle control apparatus of the present embodiment may be configured to perform the following control when the driver depresses the brake pedal during performance of the above-described post-collision control. That is, when a stop lamp switch signal is turned on in response to the operation of the brake pedal by the driver or when the pressure within the brake master cylinder exceeds a predetermined value in response to the operation of the brake pedal by the driver, the CPU 51 ends brake control for the collision, and performs brake control for ordinary travel in accordance with the operation of the brake pedal by the driver.

Moreover, the CPU 51 may operate to estimate a vehicle deceleration from the brake specifications, and the pressure within the brake master cylinder or a stepping force corresponding to the operation of the brake pedal by the driver; compare the estimated vehicle deceleration with the above-mentioned target deceleration Gtarget; end the above-described post-collision control and perform brake control for ordinary travel when the estimated vehicle deceleration is greater; and continue the post-collision control when the target deceleration Gtarget is greater.

### Second Embodiment

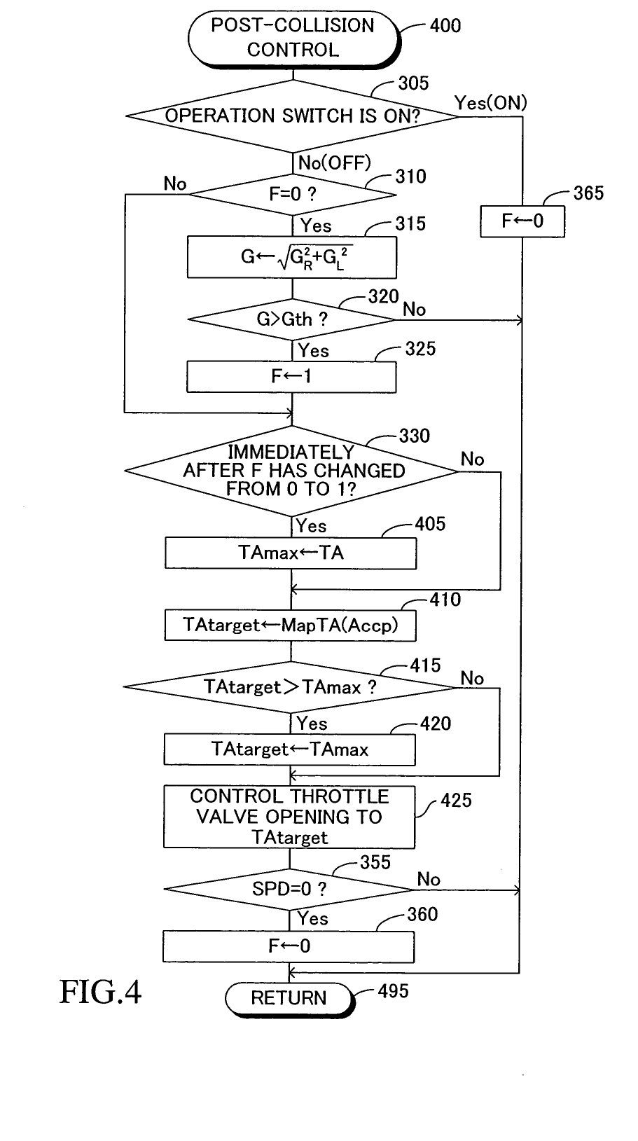

Next, a vehicle control apparatus according to a second embodiment of the present invention will be described. The vehicle control apparatus according to the second embodiment differs from the vehicle control apparatus 10 of the first embodiment only in that the CPU 51 of the vehicle control apparatus according to the second embodiment executes, at predetermined intervals, the routine (program) shown by a flowchart of FIG. 4 in place of that shown by the flowchart of FIG. 3. Therefore, this difference will be mainly described. Notably, in FIG. 4, those steps which are identical with those of FIG. 3 are denoted by the same step numbers. Further, the operation switch used in the second embodiment is a switch for designating whether to automatically control a drive force corresponding to a drive operation performed by the driver so that the drive force does not exceed a predetermined level when a collision of the vehicle is determined to have occurred.

In this embodiment as well, when the vehicle undergoes a collision during ordinary travel, the CPU 51 changes the value of the post-collision control execution flag F from “0” to “1” by means of the processing in Steps 310 to 325. As a result, the CPU 51 makes a “Yes” determination in Step 330, and proceeds to Step 405 so as to store, as an upper limit throttle valve opening TAmax, a throttle valve opening TA which is detected by means of the TA sensor 64 immediately after occurrence of the collision.

Subsequently, in Step 410, the CPU 51 calculates a target throttle valve opening TAtarget from the accelerator pedal opening Accp detected by means of the accelerator pedal sensor 66, and by use of a predetermined map.

Subsequently, in Step 415, the CPU 51 compares the upper limit throttle valve opening TAmax and the target throttle valve opening TAtarget. When the target throttle valve opening TAtarget is greater than the upper limit throttle valve opening TAmax, the CPU 51 makes a “Yes” determination in Step 415. In this case, the CPU 51 proceeds to Step 420 so as to change the target throttle valve opening TAtarget to the upper limit throttle valve opening TAmax, and then proceeds to Step 425. When the target throttle valve opening TAtarget is not greater than the upper limit throttle valve opening TAmax, the CPU 51 makes a “No” determination in Step 415, and proceeds directly to Step 425.

Subsequently, in Step 425, the CPU 51 sends to the motor 21 an instruction signal for controlling the throttle valve opening to the target throttle valve opening TAtarget. After that, the CPU 51 performs the processing in Step 355 and subsequent steps, and then proceeds to Step 495 so as to end the current execution of the present routine.

When a predetermined period of time elapses, the CPU 51 again starts the processing of the routine of FIG. 4 from Step 400. In this case, since the value of the post-collision control execution flag F is maintained at “1,” so long as the operation switch 70 is not brought into the “ON” state, the CPU 51 proceeds to Steps 305, 310, and 330, and then proceeds to Step 410 and subsequent steps, without performing the processing in Step 405. As result, irrespective of drive operations by the driver, the throttle valve opening is restricted so as not to exceed the upper limit throttle valve opening TAmax. Because of presence of Steps 355 and 360, such post-collision control is continued until the vehicle stops.

The above description applies to the case where the vehicle control apparatus comprises acceleration detection means (acceleration sensor) for detecting acceleration of a vehicle; collision determination means (Steps 310 to 325) for determining, on the basis of the detected acceleration G of the vehicle, whether the vehicle has undergone a collision; a drive source (for example, the internal combustion engine 20) for generating a drive force to drive the vehicle in accordance with an instruction signal; and instruction-signal generation means (Steps 330 and 405 to 425) for generating the instruction signal in response to a drive operation of a driver and for modifying the instruction signal, when the vehicle is determined to have undergone a collision, in such a manner that the drive force generated in accordance with the instruction signal does not exceed a predetermined level (a drive force which is determined by the throttle valve opening at the time when a collision of the vehicle is determined to have occurred).

The vehicle control apparatus of the present invention comprises the operation switch 70 for prohibiting, when a collision of the vehicle is determined to have occurred, the modification of the instruction signal, in such a manner that the drive force corresponding to an instruction signal based on a drive operation of the driver does not exceed the predetermined level.

Further, the instruction-signal generation means is configured to continue the modification of the instruction signal until the vehicle stops (Steps 355 to 360).

As described above, after occurrence of a vehicle collision, the vehicle control apparatus according to the second embodiment of the present invention, irrespective of the amount of operation of the accelerator pedal by the driver (i.e., the accelerator pedal opening Accp), forcibly controls the throttle valve opening TA to the upper limit throttle valve opening TAmax or less, to thereby suppress the output torque of the internal combustion engine 20 (the drive force of the drive source for driving the vehicle) to a predetermined level or less. Therefore, acceleration of the vehicle above a certain level is avoided, whereby the driver can cause the vehicle to travel safely.

In Step 405, the CPU 51 stores, as an upper limit throttle valve opening TAmax, a throttle valve opening TA used immediately after occurrence of a vehicle collision. However, the value of the upper limit throttle valve opening TAmax is not limited to this value. For instance, the upper limit throttle valve opening TAmax may be fixed to a predetermined value β, or may be a value (TA-γ) obtained through subtraction of a predetermined value γ from the throttle valve opening TA which is detected by means of the TA sensor 64 immediately after occurrence of a vehicle collision. Moreover, the vehicle control apparatus may be configured in such a manner that the output torque of the internal combustion engine 20 at the time when a vehicle collision is determined to have occurred is obtained from the throttle valve opening TA at that time, the rotational speed of the engine at that time, etc., and stored as an upper limit value (a predetermined drive force or level); and at least one of throttle valve opening, fuel injection quantity fi, ignition timing, etc. is controlled such that the output torque of the internal combustion engine 20 does not exceed the determined upper limit value after that time.

The present invention is not limited to the above-described embodiments, and may be modified in various manners within the scope of the present invention. For example, as described above, a sensor(s) for airbags may be used as the G_{R} sensor 61 and the G_{L} sensor 62.

Further, in all of the above-described embodiments, the following control may be performed when the operation switch 70 is turned on during performance of post-collision control. That is, a target throttle valve opening TAtarget is calculated from the accelerator pedal opening Accp and by use of a predetermined map; and the throttle valve opening is gradually increased from the predetermined value a toward the calculated TAtarget after the switch 70 is turned on. This control prevents sudden acceleration of the vehicle and enables smooth acceleration of the vehicle, immediately after the post-collision control is ended and the control for ordinary travel is started in response to the operation switch 70 being turned on in the middle of post-collision control.

In addition, if an airbag sensor has a plurality of thresholds, the deploy speed and deploy range of the air bag may be controlled stepwise in. a plurality of stages, and the target deceleration Gtarget used in the first embodiment may be changed according to the control stage.

1. A vehicle control apparatus comprising:
acceleration detection means for detecting acceleration of a vehicle;
collision determination means for determining, on the basis of the detected acceleration of the vehicle, whether the vehicle has undergone a collision; and
automatic deceleration force generation means for automatically generating a deceleration force for decelerating the vehicle when the vehicle is determined to have undergone a collision.

2. A vehicle control apparatus according to claim 1, wherein the automatic deceleration force generation means is configured to generate the deceleration force by actuating a brake of the vehicle.

3. A vehicle control apparatus according to claim 1, wherein the automatic deceleration force generation means is configured to generate the deceleration force by controlling an operating state of a drive source, which is mounted on the vehicle and adapted to generate a drive force for driving the vehicle, in such a manner that the drive source serves as a load against travel of the vehicle.

4. A vehicle control apparatus according to claim 2, wherein the automatic deceleration force generation means is configured to generate the deceleration force by controlling an operating state of a drive source, which is mounted on the vehicle and adapted to generate a drive force for driving the vehicle, in such a manner that the drive source serves as a load against travel of the vehicle.

5. A vehicle control apparatus according to claim 3, wherein the automatic deceleration force generation means is configured to shift a transmission mounted on the vehicle from a gear position at the time when the vehicle is determined to have undergone a collision to a lower-side gear position.

6. A vehicle control apparatus according to claim 4, wherein the automatic deceleration force generation means is configured to shift a transmission mounted on the vehicle from a gear position at the time when the vehicle is determined to have undergone a collision to a lower-side gear position.

7. A vehicle control apparatus according to claim 1, further comprising an operation switch for prohibiting automatic generation of the deceleration force.

8. A vehicle control apparatus according to claim 1, wherein the automatic deceleration force generation means is configured to continue automatic generation of the deceleration force until the vehicle stops.

9. A vehicle control apparatus comprising:
acceleration detection means for detecting acceleration of a vehicle;
collision determination means for determining, on the basis of the detected acceleration of the vehicle, whether the vehicle has undergone a collision;
a drive source for generating a drive force for driving the vehicle in accordance with an instruction signal;
instruction-signal generation means for generating the instruction signal in response to a drive operation of a driver and for modifying the instruction signal, when the vehicle is determined to have undergone a collision, in such a manner that the drive force generated in accordance with the instruction signal does not exceed a predetermined level.

10. A vehicle control apparatus according to claim 9, further comprising an operation switch for prohibiting the modification of the instruction signal.

11. A vehicle control apparatus according to claim 9, wherein the instruction-signal generation means is configured to continue the modification of the instruction signal until the vehicle stops.

12. A vehicle control apparatus according to claim 10, wherein the instruction-signal generation means is configured to continue the modification of the instruction signal until the vehicle stops.
